(19) United States
(12) Patent Application Publication
(10) Pub. No.: US 2020/0370904 A1
(43) Pub. Date: Nov. 26, 2020

(54) TRAVELING CONTROL APPARATUS, VEHICLE, AND TRAVELING CONTROL METHOD

(71) Applicant: HONDA MOTOR CO., LTD., MINATO-KU, TOKYO (JP)

(72) Inventors: Masaaki NAGASHIMA, WAKO-SHI, SAITAMA-KEN (JP); Hideki MATSUNAGA, WAKO-SHI, SAITAMA-KEN (JP); Takeru GOTO, WAKO-SHI, SAITAMA-KEN (JP); Takumi MACHIDA, MINATO-KU, TOKYO (JP); Toshiaki TAKANO, MINATO-KU, TOKYO (JP)

(21) Appl. No.: 16/768,451

(22) PCT Filed: Dec. 1, 2017
(86) PCT No.: PCT/JP2017/043239

§ 371 Date: May 29, 2020

(51) Int. Cl. G01C 21/34; G05D 1/02; B60W 60/00

(52) U.S. Cl. CPC G01C 21/3461; G05D 1/0214; B60W 2556/50; B60W 60/0016; G05D 2201/0212; B60W 60/00253

(57) ABSTRACT

Provided are a traveling control apparatus, a vehicle, and a traveling control method in which appropriateness of a user target destination can be taken into consideration. A traveling control apparatus acquires vicinity environment information from a vicinity environment detection unit. In addition, the traveling control apparatus determines whether or not a user target destination is appropriate for stopping a vehicle, on the basis of the vicinity environment information regarding the user target destination. Further, in the case where it is determined that the user target destination is not appropriate for stopping a vehicle, the traveling control apparatus stops a vehicle at a corrected target destination off track from the user target destination.

### TECHNICAL FIELD

The present invention relates to a travel control device, a vehicle, and a travel control method (a traveling control apparatus, a vehicle, and a traveling control method) for causing a vehicle to travel autonomously in at least a part of a route to a destination.

### BACKGROUND ART

In International Publication No. WO 2011/158347 (hereinafter, referred to as “WO 2011/158347 A1”), an object is to provide a driving assistance device that allows a driver to easily operate intuitively without a sense of discomfort ([0008] and Abstract). In order to achieve this object, in WO 2011/158347 A1, when it is instructed to perform autonomous driving through an autonomous driving switch, an autonomous driving mode is switched depending on whether a destination has been set and the driver has the intention to continue the travel.

That is to say, in a case where a destination setting unit 3 has set the destination, a course for the autonomous driving to the destination is generated and the autonomous driving is started (Abstract and S12 in FIG. 2). In a case where the destination setting unit 3 has not set the destination and a travel intention detection unit 4 has detected that the driver has the intention to continue the travel, a course for the autonomous driving along a road is generated and the autonomous driving is started (Abstract and S16 in FIG. 2). In a case where the destination setting unit 3 has not set the destination and the travel intention detection unit 4 has detected that the driver does not have the intention to continue the travel, a course for autonomous stopping is generated and the autonomous driving is started (Abstract and S18 in FIG. 2).

The destination setting unit 3 is used by the driver to set the destination for the autonomous driving, and for example may be a touch screen of a navigation system ([0027]).

### SUMMARY OF INVENTION

As described above, in WO 2011/158347 A1, when the destination is set by the destination setting unit 3, the course for the autonomous driving to the destination is generated and the autonomous driving is started (Abstract, S12 in FIG. 2). It is understood that the autonomous driving to the destination is continued until the vehicle arrives at the destination (FIG. 2). However, WO 2011/158347 A1 merely discloses to autonomously drive the vehicle to the destination that is set by the driver. In other words, whether the destination set by the driver (user) is adequate as a stop position (or the risk of the user destination) is not taken into consideration.

The present invention has been made in view of the above circumstance, and an object is to provide a travel control device, a vehicle, and a travel control method in which the adequateness of a user destination can be taken into consideration.

A travel control device according to the present invention is configured to cause a vehicle to travel autonomously in at least a part of a route to a user destination that is input by a user through a destination input unit, wherein the travel control device is configured to acquire peripheral environment information from a peripheral environment detection unit, determine whether the user destination is adequate for the vehicle to stop, on a basis of the peripheral environment information about the user destination, and if it is determined that the user destination is inadequate for the vehicle to stop, cause the vehicle to stop at a corrected destination that is shifted from the user destination.

According to the present invention, if it is determined that the user destination that is set by the user is inadequate for the vehicle to stop, the vehicle is stopped at the corrected destination that is shifted from the user destination. Thus, the vehicle can be stopped at the place adequate for the vehicle to stop. Accordingly, the user can get off the vehicle more conveniently.

If it is determined that the user destination is inadequate for the vehicle to stop, the travel control device may be configured to cause the vehicle to stop at the corrected destination that is a place over or before the user destination in a lane same as a lane of the user destination. Thus, the user destination and the corrected destination (actual position where the user gets off the vehicle) exist on the same lane. Therefore, the user can easily understand the positional relation between the user destination and the position where the user gets off the vehicle.

If it is determined that the user destination is inadequate for the vehicle to stop, the travel control device may be configured to cause the vehicle to stop at the corrected destination that is a place over or before the user destination in a lane facing a block same as a block of the user destination. Thus, the user destination and the corrected destination (actual position where the user gets off the vehicle) exist in the same block (section). Therefore, the user can easily understand the positional relation between the user destination and the position where the user gets off the vehicle.

If it is determined that the user destination is inadequate for the vehicle to stop, the travel control device may be configured to cause the vehicle to turn left or right after passing the user destination and to stop at the corrected destination that is a place over the user destination in the lane facing the same block as the block of the user destination. Thus, the vehicle stops so as to face the same block (section) as the user destination after passing the user destination. Therefore, the user can understand more easily the positional relation between the user destination and the position where the user gets off the vehicle.

If it is determined that the user destination is inadequate for the vehicle to stop, the travel control device may be configured to notify through a notification unit that the vehicle goes to the corrected destination that is shifted from the user destination. Therefore, the user can find that the vehicle is in the normal operation.

If it is determined that the user destination is in an intersection, in a railroad crossing, in a construction area, or in a periphery of any of these places, the travel control device may be configured to cause the vehicle to stop at the corrected destination that is out of the intersection, the railroad crossing, the construction area, or the periphery of any of these places. Thus, even if the user destination is in the intersection, in the railroad crossing, in the construction area, or in the periphery of any of these places, the user can get off the vehicle at the adequate place.

If it is determined that other vehicle stops at the user destination or in a periphery thereof, the travel control device may be configured to cause the vehicle to stop ahead of or behind the other vehicle. Thus, even if the other vehicle stops at the user destination, the user can get off the vehicle at the adequate place.

A vehicle according to the present invention includes the aforementioned travel control device and an automatic door, wherein if it is determined that the user destination is inadequate for the vehicle to stop, the travel control device is configured to cause the vehicle to stop at the corrected destination that is shifted from the user destination and open the automatic door automatically.

Thus, the user can recognize that the current autonomous driving ends.

A travel control method according to the present invention includes: a user destination receiving step of receiving a user destination from a user through a destination input unit; an information acquisition step of acquiring peripheral environment information from a peripheral environment detection unit; and an autonomous travel step of causing a travel control device to make a vehicle travel autonomously in at least a part of a route to the user destination, wherein in the autonomous travel step, whether the user destination is adequate for the vehicle to stop is determined on a basis of the peripheral environment information about the user destination, and if it is determined that the user destination is inadequate for the vehicle to stop, the vehicle is stopped at a corrected destination that is shifted from the user destination.

### BRIEF DESCRIPTION OF DRAWINGS

FIG. 1 is a block diagram schematically illustrating a configuration of a vehicle according to one embodiment of the present invention;

FIG. 2 is a diagram illustrating each unit of a calculation device of an AD unit according to the embodiment and a periphery thereof;

FIG. 3 is a flowchart of autonomous driving control in the embodiment;

FIG. 4 is a flowchart of an arrival process in the embodiment (details of S16 in FIG. 3);

FIG. 5 is a diagram illustrating an example in which a plurality of other vehicles stop at a vehicle destination and in a periphery thereof in the embodiment; and

FIG. 6 is a flowchart of an alternative place searching process in the embodiment (details of S25 in FIG. 4).

### DESCRIPTION OF EMBODIMENT

### A. Embodiment

### A-1. Configuration

### [A-1-1. Summary]

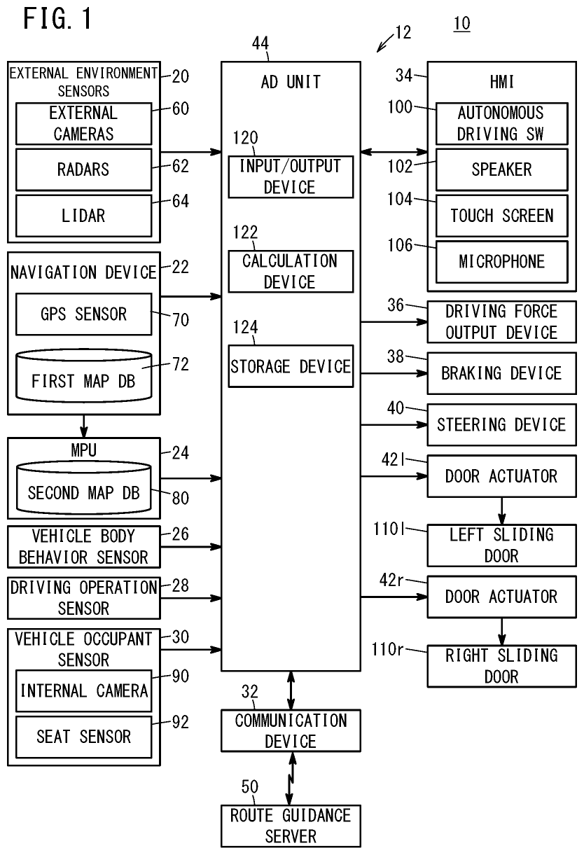

FIG. 1 is a block diagram schematically illustrating a configuration of a vehicle 10 according to one embodiment of the present invention. The vehicle 10 (hereinafter also referred to as “user's own vehicle 10”) includes external environment sensors 20, a navigation device 22, a map positioning unit 24 (hereinafter referred to as “MPU 24”), a vehicle body behavior sensor 26, a driving operation sensor 28, a vehicle occupant sensor 30, a communication device 32, a human-machine interface 34 (hereinafter referred to as “HMI 34”), a driving force output device 36, a braking device 38, a steering device 40, door actuators 421, 42r, and an AD unit 44. The term “AD” of the AD unit 44 is the abbreviation for autonomous driving. The navigation device 22, the MPU 24, and the AD unit 44 form a travel control device 12.

### [A-1-2. External Environment Sensors 20]

The external environment sensors 20 (periphery monitoring sensors) detect information about the external environment around the vehicle 10 (hereinafter this information is also referred to as “external environment information Ie”). The external environment sensors 20 include a plurality of external cameras 60, a plurality of radars 62, and a LIDAR 64 (Light Detection And Ranging).

The external cameras 60 capture images around the vehicle 10 (front, side, and rear) to obtain peripheral images Fs, and output image information Iimage about the peripheral images Fs. The radars 62 output radar information Iradar expressing reflection waves of electromagnetic waves that have been transmitted to the periphery of the vehicle 10 (front, side, and rear). The LIDAR 64 continuously outputs lasers in all directions of the vehicle 10, measures a three-dimensional position of a reflection point on the basis of the reflection waves of the output lasers, and outputs the three-dimensional position as three-dimensional information Ilidar.

### [A-1-3. Navigation Device 22]

The navigation device 22 calculates a target route Rtar from a current position Pcur to a destination Ptar, shows the target route Rtar to a vehicle occupant, and outputs the target route Rtar to the MPU 24. As illustrated in FIG. 1, the navigation device 22 includes a global positioning system sensor 70 (hereinafter referred to as “GPS sensor 70”) and a first map database 72 (hereinafter referred to as “map DB 72” or “first map DB 72”). The GPS sensor 70 detects the current position Pcur of the vehicle 10. The first map DB 72 stores map information Imap.

The navigation device 22 receives the input of the destination Ptar from the user (hereinafter also referred to as “user destination Putar”) through the HMI 34 (particularly, touch screen 104 or microphone 106). Then, the navigation device 22 calculates the target route Rtar from the current position Pcur to the user destination Putar using the map information Imap in the first map DB 72. In the case where the autonomous driving control is currently performed, the navigation device 22 transmits the target route Rtar to the MPU 24. The target route Rtar is used in the autonomous driving control.

### [A-1-4. MPU 24]

The MPU 24 manages a second map database 80 (hereinafter referred to as “second map DB 80”). Map information Imap stored in the second map DB 80 is more precise than the map information Imap in the first map DB 72, and the accuracy of position of the map information Imap in the second map DB 80 is less than or equal to centimeters. While the first map DB 72 does not include the detailed information about the lanes of the roads, the second map DB 80 includes the detailed information about the lanes of the roads. The MPU 24 reads, from the second map DB 80, the map information Imap (high-precision map) corresponding to the target route Rtar received from the navigation device 22, and transmits the map information Imap to the AD unit 44. The map information Imap (high-precision map) corresponding to a target trajectory Ltar is used in the autonomous driving control.

### [A-1-5. Vehicle Body Behavior Sensor 26]

The vehicle body behavior sensor 26 detects information about the behavior of the vehicle 10 (vehicle body in particular) (hereinafter this information is also referred to as “vehicle body behavior information Ib”). The vehicle body behavior sensor 26 includes a vehicle speed sensor, an acceleration sensor, and a yaw rate sensor (none of them are shown). The vehicle speed sensor detects a vehicle speed V [km/h] and the traveling direction of the vehicle 10. The acceleration sensor detects an acceleration G [m/s/s] of the vehicle 10. The acceleration G includes a longitudinal acceleration a, a lateral acceleration Glat, and a vertical acceleration Gv (or may be any one of these accelerations). The yaw rate sensor detects a yaw rate Y [rad/s] of the vehicle 10.

### [A-1-6. Driving Operation Sensor 28]

The driving operation sensor 28 detects information regarding driving operation of a driver (this information is hereinafter also referred to as “driving operation information Ido”). The driving operation sensor 28 includes an accelerator pedal sensor and a brake pedal sensor (neither are shown). The accelerator pedal sensor detects the operation amount [%] of an accelerator pedal that is not shown. The brake pedal sensor detects the operation amount [%] of a brake pedal that is not shown. The driving operation sensor 28 may include a steering angle sensor and a steering torque sensor (neither are shown), for example.

### [A-1-7. Vehicle Occupant Sensor 30]

The vehicle occupant sensor 30 detects information regarding the state of the vehicle occupant (not related to the driving operation directly) (this information is hereinafter also referred to as “vehicle occupant information Io”). The vehicle occupant sensor 30 includes an internal camera 90 and a seat sensor 92. The internal camera 90 is a driver monitoring camera that captures the driver's face and a periphery thereof. The seat sensor 92 is a pressure sensor provided to a seat cushion that is not shown. The vehicle occupant sensor 30 may include a seat belt sensor that detects whether the vehicle occupant wears a seat belt that is not shown.

### [A-1-8. Communication Device 32]

The communication device 32 communicates wirelessly with external devices. Examples of the external devices include a route guide server 50. It is assumed that the communication device 32 according to the present embodiment is mounted (or normally fixed) in the vehicle 10; however, for example, the communication device 32 may be carried out of the vehicle 10 like a mobile phone or a smart phone.

### [A-1-9. HMI 34]

The HMI 34 (destination input unit, notification unit) receives an operation input from the vehicle occupant, and shows various pieces of information to the vehicle occupant visually, audibly, and haptically. The HMI 34 includes an autonomous driving switch 100 (hereinafter also referred to as “autonomous driving SW 100”), a speaker 102, the touch screen 104, and the microphone 106.

The autonomous driving SW 100 is a switch for the vehicle occupant to order start or stop of the autonomous driving control. In addition to or instead of the autonomous driving SW 100, another method (for example, voice input through microphone 106) may be employed to order start or stop of the autonomous driving control. The touch screen 104 includes, for example, a liquid crystal panel or an organic EL panel.

### [A-1-10. Driving Force Output Device 36]

The driving force output device 36 includes a travel driving source (an engine, a traction motor, or the like) and a driving electronic control unit (hereinafter referred to as “driving ECU”) that are not shown. The driving ECU controls the travel driving source on the basis of the operation amount of the accelerator pedal or the instruction from the AD unit 44 so as to adjust the travel driving force of the vehicle 10.

### [A-1-11. Braking Device 38]

The braking device 38 includes a brake motor (or hydraulic mechanism), a brake member, and a braking electronic control unit (hereinafter referred to as “braking ECU”) that are not shown. The braking device 38 may control engine brake by an engine and/or regenerative brake by a travel motor. The braking ECU controls the braking force of the vehicle 10 by operating the brake motor or the like on the basis of the operation amount of the brake pedal or the instruction from the AD unit 44.

### [A-1-12. Steering Device 40]

The steering device 40 includes an electric power steering (EPS) motor and an EPS electronic control unit (hereinafter referred to as “EPS ECU”) that are not shown. The EPS ECU controls the EPS motor in accordance with the driver's operation of a steering wheel or the instruction from the AD unit 44 so as to control the steering angle of the vehicle 10.

[A-1-13. Door Actuators 421, 42r]

The door actuator 421 automatically opens/closes a left sliding door 1101 on the basis of the instruction from the AD unit 44. The door actuator 42r automatically opens/closes a right sliding door 110r on the basis of the instruction from the AD unit 44.

### [A-1-14. AD Unit 44]

### (A-1-14-1. Summary of AD Unit 44)

The AD unit 44 performs the autonomous driving control for driving the vehicle 10 to the destination Ptar without requiring the driver's driving operation (acceleration, deceleration, and steering), and includes, for example, a central processing unit (CPU). The AD unit 44 includes an input/output device 120, a calculation device 122, and a storage device 124.

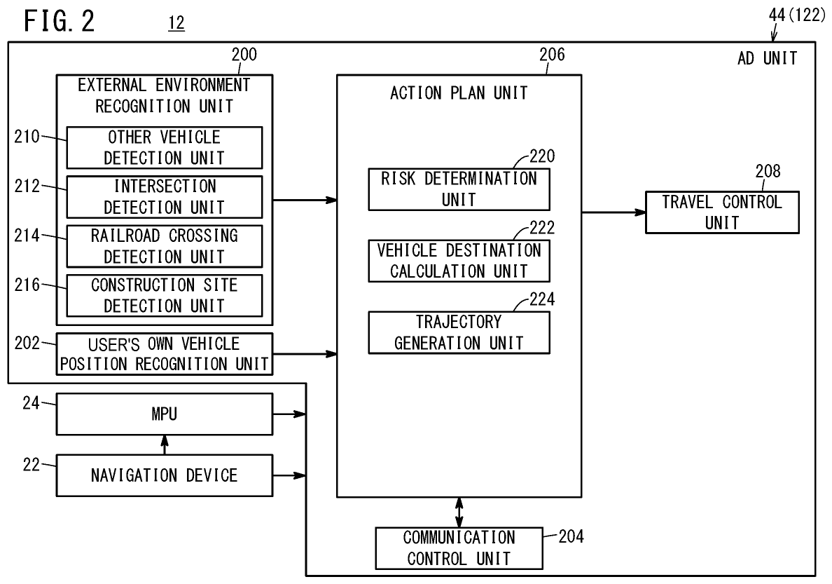

The input/output device 120 performs input/output with the devices other than the AD unit 44 (sensors 20, 26, 28, 30, etc.). The calculation device 122 performs calculation on the basis of signals from the sensors 20, 26, 28, 30, the navigation device 22, the MPU 24, the communication device 32, the HMI 34, and the like. The calculation device 122 generates signals for the communication device 32, the HMI 34, the driving force output device 36, the braking device 38, and the steering device 40 on the basis of a calculation result. The details of the calculation device 122 are described below with reference to FIG. 2.

The storage device 124 stores programs and data that are used by the calculation device 122. The storage device 124 includes, for example, a random access memory (hereinafter referred to as “RAM”). As the RAM, a volatile memory such as a register and a nonvolatile memory such as a flash memory can be used. In addition to the RAM, the storage device 124 may include a read only memory (ROM) and/or a solid state drive (SSD).

### (A-1-14-2. Calculation Device 122)

FIG. 2 is a diagram illustrating each unit of the calculation device 122 of the AD unit 44 according to the present embodiment and a periphery thereof. As illustrated in FIG. 2, the calculation device 122 in the AD unit 44 includes an external environment recognition unit 200, a user's own vehicle position recognition unit 202, a communication control unit 204, an action plan unit 206, and a travel control unit 208. These units are achieved when, for example, the calculation device 122 (such as CPU) executes the programs stored in the storage device 124 in the AD unit 44. The programs may be supplied from an external management server (not shown) through the communication device 32. A part of the programs may be formed by hardware (circuit component).

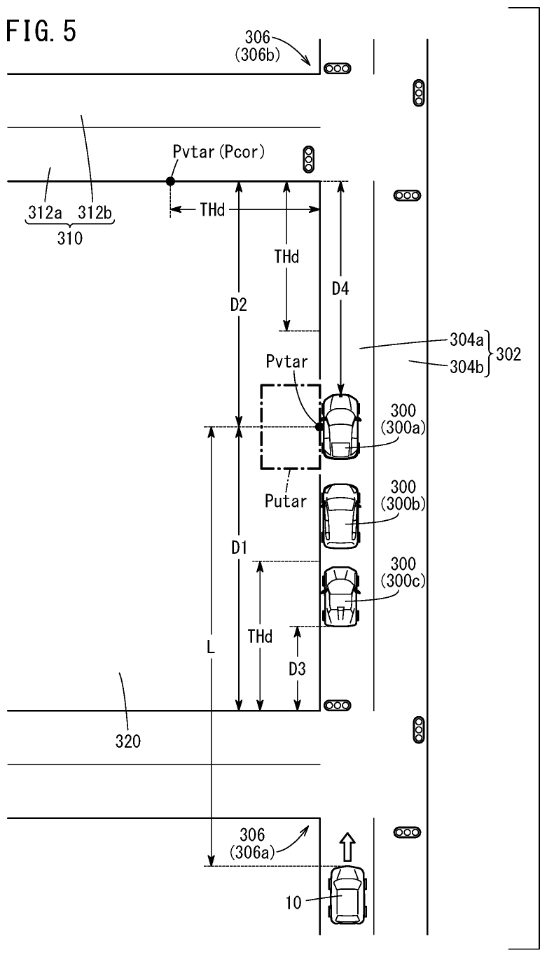

The external environment recognition unit 200 recognizes the circumstances and objects around the user's own vehicle 10 on the basis of the external environment information Ie from the external environment sensors 20 (FIG. 1). The external environment recognition unit 200 recognizes an overall road environment such as a road shape, a road width, a position of a lane mark, the number of lanes, a lane width, a lighting state of a traffic signal, and an open/close state of a crossing gate on the basis of the image information Iimage from the external cameras 60. The external environment recognition unit 200 includes an other vehicle detection unit 210, an intersection detection unit 212, a railroad crossing detection unit 214, and a construction site detection unit 216. The other vehicle detection unit 210 detects another vehicle 300 (FIG. 5) existing near the user's own vehicle 10. To detect the other vehicle 300, the image information Iimage from the external camera 60 is used. Alternatively, the other vehicle detection unit 210 may detect the other vehicle 300 by communicating with the other vehicle through the communication device 32.

The intersection detection unit 212 detects an intersection 306 (FIG. 5) existing near the user's own vehicle 10. To detect the intersection 306, the image information Iimage from the external camera 60 is used. Alternatively, the intersection detection unit 212 may detect the intersection 306 using the current position Pcur of the user's own vehicle 10 and the map information Imap. Further alternatively, the intersection detection unit 212 may detect the intersection 306 by communicating with a beacon on a road side (not shown) through the communication device 32.

The railroad crossing detection unit 214 detects a railroad crossing (not shown) existing near the user's own vehicle 10. To detect the railroad crossing, the image information Iimage from the external camera 60 is used. Alternatively, the railroad crossing detection unit 214 may detect the railroad crossing using the current position Pcur of the user's own vehicle 10 and the map information Imap. Further alternatively, the railroad crossing detection unit 214 may detect the railroad crossing by communicating with the beacon on the road side (not shown) through the communication device 32.

The construction site detection unit 216 detects a construction site (not shown) existing near the user's own vehicle 10. To detect the construction site, the image information Iimage from the external camera 60 is used. Alternatively, the construction site detection unit 216 may detect the construction site using the current position Pcur of the user's own vehicle 10 and construction information from the route guide server 50. Further alternatively, the construction site detection unit 216 may detect the construction site by communicating with the beacon on the road side (not shown) through the communication device 32.

The user's own vehicle position recognition unit 202 recognizes the current position Pcur of the user's own vehicle 10 with high accuracy on the basis of recognition results from the external environment recognition unit 200, the map information Imap from the MPU 24, and the current position Pcur from the navigation device 22. The communication control unit 204 controls the communication between the AD unit 44 and the devices outside the vehicle (for example, route guide server 50).

The action plan unit 206 determines the travel circumstance of the user's own vehicle 10 on the basis of the map information Imap (high-precision map) from the MPU 24, the recognition results from the external environment recognition unit 200 and the user's own vehicle position recognition unit 202, and a detection result from the vehicle body behavior sensor 26, and decides various actions of the user's own vehicle 10. Specifically, the action plan unit 206 calculates the target trajectory Ltar, the target vehicle speed Vtar, and the like.

As illustrated in FIG. 2, the action plan unit 206 includes a risk determination unit 220, a vehicle destination calculation unit 222, and a trajectory generation unit 224. The risk determination unit 220 determines a risk R (details are described below) of the destination Ptar (user destination Putar) that is input by the user through the HMI 34. The vehicle destination calculation unit 222 calculates the destination Ptar (hereinafter also referred to as “vehicle destination Pvtar”) where the vehicle 10 actually stops, on the basis of the user destination Putar, the map information Imap from the MPU 24, and the risk R. The trajectory generation unit 224 generates the target trajectory Ltar to the vehicle destination Pvtar, and causes the vehicle 10 to travel autonomously to the vehicle destination Pvtar.

The target route Rtar calculated by the navigation device 22 is used to show the driver the road to advance, and is relatively rough. On the other hand, the target trajectory Ltar calculated by the action plan unit 206 includes, in addition to the rough trajectory calculated by the navigation device 22, a relatively precise content for controlling the acceleration, deceleration, and steering of the vehicle 10.

The travel control unit 208 calculates a control instruction for the driving force output device 36, the braking device 38, and the steering device 40 on the basis of a decision result of the action plan unit 206 (target trajectory Ltar, target vehicle speed Vtar, or the like), and transmits the control instruction thereto. In other words, the travel control unit 208 controls the output of each actuator that controls the vehicle body behavior. The actuator herein described includes an engine, a brake motor, an EPS motor, and the like. The travel control unit 208 controls the output of the actuator so as to control the amount of behavior of the vehicle 10 (particularly, vehicle body) (hereinafter this amount is referred to as “vehicle body behavior amount Qb”). The vehicle body behavior amount Qb herein described includes, for example, the vehicle speed V, the longitudinal acceleration a, a steering angle Est, the lateral acceleration Glat, and the yaw rate Y.

### [A-1-15. Route Guide Server 50]

The route guide server 50 generates or calculates the target route Rtar to the destination Ptar instead of the vehicle 10 on the basis of the current position Pcur of the vehicle 10 and the destination Ptar that are received from the communication device 32. The route guide server 50 includes an input/output device, a communication device, a calculation device, and a storage device that are not shown. The storage device stores programs and data that are used by the calculation device.

### A-2. Control in the Present Embodiment

### [A-2-1. Summary]

The vehicle 10 according to the present embodiment can perform the autonomous driving control for causing the vehicle 10 to travel autonomously to the destination Ptar. The autonomous driving control is performed by the navigation device 22, the MPU 24, and the AD unit 44 (that is, the travel control device 12).

In the present embodiment, in a case where the destination Ptar designated by the user (user destination Putar) is a point that is (on the road but) inadequate for the vehicle to stop (stop inadequate point), a point shifted from the user destination Putar is set as the actual destination Ptar (vehicle destination Pvtar). In a case where the user destination Putar is a point adequate for the vehicle to stop (stop adequate point), the user destination Putar is kept as the vehicle destination Pvtar.

### [A-2-2. Autonomous Driving Control]

### (A-2-2-1. Summary)

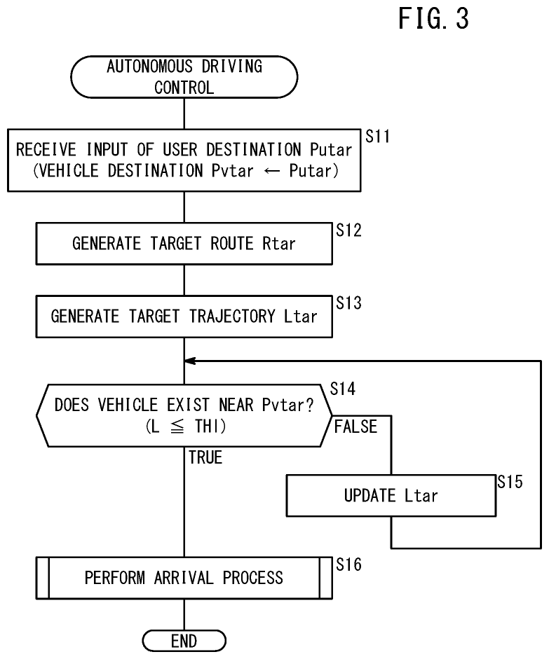

FIG. 3 is a flowchart of the autonomous driving control in the present embodiment. In step S11, the navigation device 22 receives the input of the destination Ptar (user destination Putar) from the user through the HMI 34 (touch screen 104, microphone 106, etc.). The user destination Putar that is input may be a portion with an area in the first map DB 72 (for example, facility name, address). The user destination Putar as the portion with the area includes a reference coordinate that is defined as a point. The reference coordinate is specified as an XY coordinate.

Alternatively, the user destination Putar may be a portion that is defined as a point in the first map DB 72. The user destination Putar that is defined as the point is set as a point that the user is in contact with, or the user designates with a cursor on a map screen (not shown) that is displayed on the touch screen 104, for example.

Then, the AD unit 44 employs the user destination Putar (or reference coordinate thereof) as the vehicle destination Pvtar (Pvtar←Putar). Note that the vehicle destination Pvtar here is the portion that is defined as the point in the first map DB 72, and the XY coordinate thereof is specified. However, the vehicle destination Pvtar may be defined as a portion with an area (for example, region with length and width of several meters). In this case, it is necessary to set a reference point for generating the target route Rtar.

If the user designates a place that is not on the road, for example a lake, the navigation device 22 sets a point on the road based on the point designated by the user (for example, the point on the road closest to the user designated point) as the user destination Putar. The term “on the road” herein described means not just the point in the lane of the road but also a region expressing a facility facing the road.

In step S12, the navigation device 22 generates the target route Rtar from the current position Pcur to the vehicle destination Pvtar. In addition, the navigation device 22 notifies the generated target route Rtar to the MPU 24.

In step S13, the MPU 24 reads, from the second map DB 80, the map information Imap (high-precision map) corresponding to the target route Rtar received from the navigation device 22, and transmits the map information Imap to the AD unit 44. The AD unit 44 generates the target trajectory Ltar on the basis of the map information Imap (high-precision map) from the MPU 24, and the recognition results from the external environment recognition unit 200 and the user's own vehicle position recognition unit 202. Moreover, the AD unit 44 controls the driving force output device 36, the braking device 38, the steering device 40, and the like on the basis of the target trajectory Ltar.

In the present embodiment, the target route Rtar is the relatively long trajectory from the current position Pcur to the vehicle destination Pvtar, while the target trajectory Ltar is the relatively short trajectory that is required to autonomously drive the vehicle 10. Note that the target route Rtar and the target trajectory Ltar may be used altogether.

In step S14, the AD unit 44 determines whether the user's own vehicle 10 exists near the vehicle destination Pvtar. This determination is performed on the basis of whether, for example, a distance L from the current position Pcur of the user's own vehicle 10 to the vehicle destination Pvtar is less than or equal to a distance threshold TH1. Alternatively, the determination may be performed on the basis of whether an estimated time Te until the user's own vehicle 10 arrives at the vehicle destination Pvtar is less than or equal to a time threshold THte.

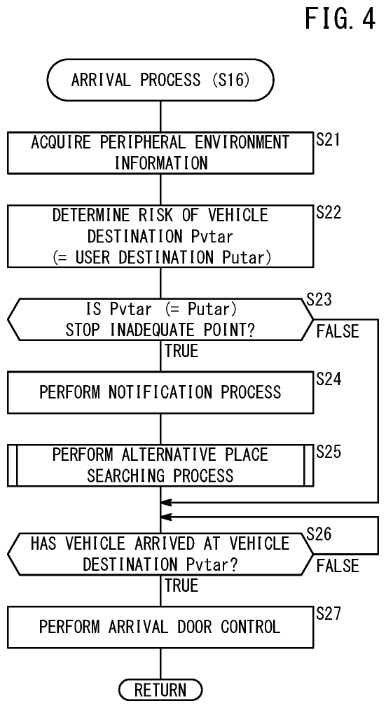

If the user's own vehicle 10 does not exist near the vehicle destination Pvtar (S14: FALSE), the AD unit 44 updates the target trajectory Ltar regarding the distance for which the vehicle 10 has advanced while keeping the vehicle destination Pvtar in step S15, and then the process returns to step S14. If the vehicle 10 exists near the vehicle destination Pvtar (S14: TRUE), the AD unit 44 performs an arrival process in step S16 (details are described below with reference to FIG. 4).

### (A-2-2-2. Arrival Process (S16 in FIG. 3))

### (A-2-2-2-1. Summary)

FIG. 4 is a flowchart of the arrival process in the present embodiment (details of S16 in FIG. 3). In step S21, the AD unit 44 acquires peripheral environment information Ise for determining whether the vehicle destination Pvtar is a point Pad that is adequate for the vehicle to stop (hereinafter this point is also referred to as “stop adequate point Pad”). The peripheral environment information Ise is, for example, the external environment information Ie from the external environment sensors 20 (image information Iimage from the external camera 60). Alternatively, the peripheral environment information Ise may include the map information Imap from the MPU 24, the current position Pcur from the navigation device 22, and the like. Further alternatively, the peripheral environment information Ise may include the recognition results from the external environment recognition unit 200 and the user's own vehicle position recognition unit 202.

In step S22, the AD unit 44 determines the risk R of the vehicle destination Pvtar that is set in step S11 in FIG. 3. The risk R is the information expressing whether the point is the stop adequate point Pad or the stop inadequate point Pia. The stop inadequate point Pia means the point that is on the road but is inadequate for the vehicle to stop.

For example, the AD unit 44 determines whether the other vehicle 300 (FIG. 5) exists at the vehicle destination Pvtar or in a periphery thereof on the basis of the external environment information Ie (or the recognition result from the external environment recognition unit 200 based on this external environment information Ie). In addition, the AD unit 44 determines whether the vehicle destination Pvtar exists in the intersection 306 (FIG. 5), in the railroad crossing, in the construction site, or in the periphery thereof. Whether the destination is in “the periphery” is determined on the basis of, for example, whether a distance Du between the vehicle destination Pvtar and a reference point Preff of each of the intersection 306, the railroad crossing, and the construction site is within a distance threshold THdu.

If it is determined that the other vehicle 300 does not exist at the vehicle destination Pvtar or in the periphery thereof and the vehicle destination Pvtar does not exist in the railroad crossing, in the intersection 306, in the construction site, or in the periphery thereof, the AD unit 44 determines that the vehicle destination Pvtar is the stop adequate point Pad (sets the risk R expressing this determination). If it is determined that the other vehicle 300 exists at the vehicle destination Pvtar or in the periphery thereof or the vehicle destination Pvtar exists in the intersection 306, the railroad crossing, in the construction site, or in the periphery thereof, the AD unit 44 determines that the vehicle destination Pvtar is the stop inadequate point Pia (sets the risk R expressing this determination).

Even in the case where the vehicle destination Pvtar is in the periphery of the intersection 306, the railroad crossing, or the construction site, if there is a parking lot, the AD unit 44 may determine that the parking lot is the stop adequate point Pad.

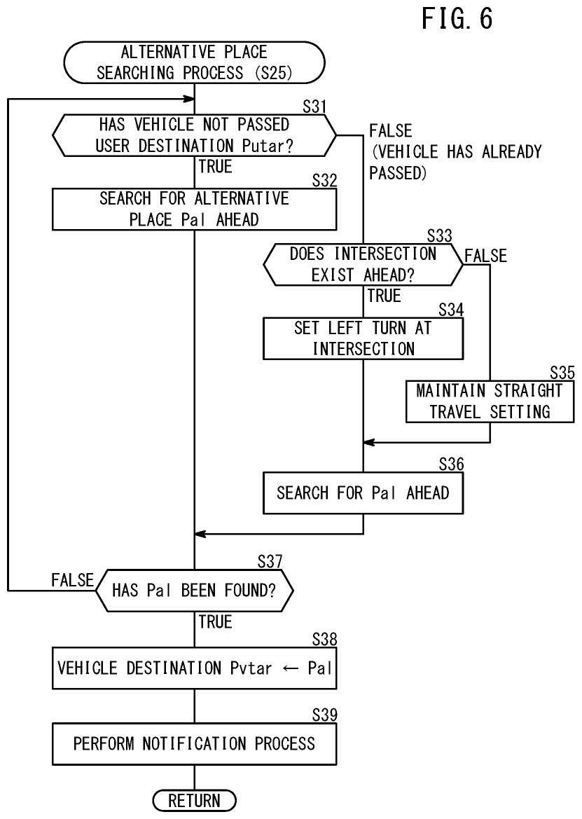

In the case where the vehicle destination Pvtar is the stop inadequate point Pia (S23 in FIG. 4: TRUE), the AD unit 44 notifies the vehicle occupant (user) through the HMI 34 (touch screen 104 and/or speaker 102) that the vehicle destination Pvtar (=user destination Putar) is changed in step S24 (notification process). In the next step S25, the AD unit 44 performs an alternative place searching process of searching for an alternative place Pal and setting the alternative place Pal as the new vehicle destination Pvtar. The alternative place searching process is described below with reference to FIG. 6. If the vehicle destination Pvtar is not the stop inadequate point Pia (S23 in FIG. 4: FALSE) or after the alternative place searching process is performed (S25), the process advances to step S26.

In step S26, the AD unit 44 determines whether the vehicle 10 has arrived at the vehicle destination Pvtar. If the vehicle has not arrived at the vehicle destination Pvtar yet (S26: FALSE), the process returns to step S26 in a state where the target trajectory Ltar is updated. The process may return to step S23 instead of step S26. If the vehicle has arrived at the vehicle destination Pvtar (S26: TRUE), the AD unit 44 performs arrival door control in step S27. The arrival door control is described below in detail.

### (A-2-2-2-2. Alternative Place Searching Process (S25 in FIG. 4))

As described above, if the vehicle destination Pvtar is the stop inadequate point Pid (S23 in FIG. 4: TRUE), the alternative place searching process is performed, that is, the alternative place Pal is selected and set as the new vehicle destination Pvtar.

FIG. 5 is a diagram illustrating an example in which a plurality of other vehicles 300 stop at the vehicle destination Pvtar and in the periphery thereof. In FIG. 5, a road 302 where the user's own vehicle 10 travels includes one lane on each side, and includes a travel lane 304a where the user's own vehicle 10 travels, and an opposite lane 304b. In FIG. 5, the intersections 306 exist before and over the vehicle destination Pvtar. To make it easier to understand, three other vehicles 300 are denoted by 300a, 300b, and 300c, and two intersections 306 are denoted by 306a and 306b.

Each of a distance D1 between the vehicle destination Pvtar and the intersection 306a, and a distance D2 between the vehicle destination Pvtar and the intersection 306b is more than or equal to a distance threshold THd; therefore, from the viewpoint of the relation with the intersections 306a and 306b, the vehicle 10 can stop. However, since the other vehicles 300a, 300b, and 300c exist, the vehicle 10 cannot stop at the vehicle destination Pvtar, or before or over the vehicle destination Pvtar.

That is to say, the other vehicle 300a stops at the vehicle destination Pvtar. In addition, the other vehicles 300b, 300c exist between the other vehicle 300a and the intersection 306a. A distance D3 between the intersection 306a and the other vehicle 300c closest to the intersection 306a is less than the distance threshold THd, and there is no space for the user's own vehicle 10 to stop.

Furthermore, the other vehicles do not exist between the other vehicle 300a and the intersection 306b. However, a difference D4−THd between the distance threshold THd and a distance D4 from the other vehicle 300a to the intersection 306b is less than the total of the longitudinal length of the user's own vehicle 10 and the allowance. Thus, the user's own vehicle 10 cannot stop between the other vehicle 300a and the intersection 306b (or the new vehicle destination Pvtar cannot be set).

In view of this, the new vehicle destination Pvtar (hereinafter also referred to as “corrected destination Pcor”) is set on a road 310 (travel lane 312a, opposite lane 312b) that branches from the intersection 306b ahead of the vehicle 10 to the left, and the details are described below. The corrected destination Pcor is set at a point that is the distance threshold THd or more away from the intersection 306.

Note that the user destination Putar in FIG. 5 is defined as the portion with the area, and the reference point thereof exists at the same position as the vehicle destination Pvtar in FIG. 5.

FIG. 6 is a flowchart of the alternative place searching process in the present embodiment (details of S25 in FIG. 4). In step S31 in FIG. 6, the AD unit 44 determines whether the vehicle 10 has not passed the vehicle destination Pvtar (=user destination Putar). If the vehicle 10 has not passed the vehicle destination Pvtar (S31: TRUE), the AD unit 44 searches for the alternative place Pal that can serve as the new vehicle destination Pvtar (corrected destination Pcor) ahead of the vehicle 10 in step S32. In this case, if the alternative place Pal is not a parking lot, the alternative place Pal is set on the lane side that faces the current vehicle destination Pvtar.

In the case where vehicles keep left as illustrated in FIG. 5, stopping the vehicle 10 with the user destination Putar on the left side in the traveling direction of the vehicle 10 allows the user to go out of the vehicle 10 to the user destination Putar without crossing the road. For this reason, the alternative place Pal is set on the lane side (in FIG. 5, lane 304a or 312a) that faces the user destination Putar (that is closer to the user destination Putar).

In addition, if the alternative place Pal is not a parking lot, the place that is closest to the current vehicle destination Pvtar (=user destination Putar) is set as the alternative place Pal. Thus, the distance for which the user needs to walk from the vehicle 10 to the user destination Putar is short.

If the vehicle 10 has already passed the vehicle destination Pvtar (S31: FALSE), in other words, after the vehicle passed the vehicle destination Pvtar, the process advances to step S33.

In step S33, the vehicle 10 determines whether the intersection (for example, intersection 306b in FIG. 5) exists ahead of the vehicle 10. If the intersection exists ahead of the vehicle 10 (S33: TRUE), the AD unit 44 sets the left turn at the intersection in step S34 (the target trajectory Ltar for the left turn is generated in S15 in FIG. 3).

Thus, the corrected destination Pcor exists in a block 320 (FIG. 5) same as the block 320 of the initial vehicle destination Pvtar (=user destination Putar). In other words, the vehicle 10 is stopped at the corrected destination Pcor, which is the place over the user destination Putar in the lane facing the same block 320 as the user destination Putar. If the intersection does not exist ahead of the vehicle 10 (S33: FALSE), the AD unit 44 maintains the straight travel (setting of the travel along the road) in step S35.

After step S34 or S35, the AD unit 44 searches for the alternative place Pal that can be the new vehicle destination Pvtar ahead of the vehicle 10 in step S36. Step S36 is performed in a manner similar to step S32. However, if the result of step S34 indicates that the vehicle 10 is about to turn left or is currently turning left in the intersection 306b, the vehicle 10 searches for the alternative place Pal for the new travel lane after turning left. For example, in FIG. 5, in the case where the vehicle 10 traveling in the travel lane 304a has passed the vehicle destination Pvtar, the AD unit 44 searches for the alternative place Pal for the new travel lane 312a.

After step S32 or S36, the AD unit 44 determines whether the alternative place Pal is found in step S37. If the alternative place Pal is not found (S37: FALSE), the AD unit 44 updates the target trajectory Ltar for the distance for which the vehicle 10 has advanced, and then the process returns to step S31.

If the alternative place Pal is found (S37: TRUE), the AD unit 44 sets the alternative place Pal as the new vehicle destination Pvtar in step S38. In order to distinguish from the initial vehicle destination Pvtar (=user destination Putar), the new vehicle destination Pvtar is also referred to as the corrected destination Pcor. In the subsequent step S39, the AD unit 44 notifies the vehicle occupant (user) through the HMI 34 (touch screen 104 and/or speaker 102) that the corrected destination Pcor has been set (notification process).

### (A-2-2-2-3. Arrival Door Control (S27 in FIG. 4))

If the vehicle 10 has arrived at the vehicle destination Pvtar (S26 in FIG. 4: TRUE), the AD unit 44 performs the arrival door control (step S27). As described above, the target trajectory Ltar causes the vehicle 10 to stop so that the vehicle destination Pvtar is on the left side of the vehicle 10 (if vehicles keep left). When the vehicle 10 has arrived at the vehicle destination Pvtar, the AD unit 44 operates the door actuator 421 to open the left sliding door 1101.

Note that in a case where the vehicle 10 includes front seats (driver's seat and passenger's seat) and rear seats and the sliding door 1101 is disposed for the rear seat, when the detection result from the vehicle occupant sensor 30 indicates the presence of the vehicle occupant only in the driver's seat, the AD unit 44 may keep the sliding door 1101 closed.

### A-3. Effects of the Present Embodiment

As described above, in the present embodiment, if it is determined that the user destination Putar set by the user (=initial vehicle destination Pvtar) is inadequate for the vehicle to stop (S23 in FIG. 4: TRUE), the vehicle 10 is stopped at the corrected destination Pcor that is shifted from the user destination Putar (S25 in FIG. 4, FIG. 5, FIG. 6). Thus, the vehicle 10 can be stopped at the place that is adequate to stop. Accordingly, the user can get off the vehicle more conveniently.

In the present embodiment, if it is determined that the user destination Putar is inadequate for the vehicle to stop (S23 in FIG. 4: TRUE), the AD unit 44 (travel control device 12) causes the vehicle 10 to stop at the corrected destination Pcor that is a place before or over the user destination Putar in the same lane 304a as the user destination Putar (S32 in FIG. 6, etc.). Thus, the user destination Putar and the corrected destination Pcor (actual position where the user gets off the vehicle) exist on the same lane. Therefore, the user can easily understand the positional relation between the user destination Putar and the position where the user gets off the vehicle.

In the present embodiment, if it is determined that the user destination Putar is inadequate for the vehicle to stop (S23 in FIG. 4: TRUE), the AD unit 44 (travel control device 12) causes the vehicle 10 to stop at the corrected destination Pcor that is a place before or over the user destination Putar in the lane 312a facing the same block 320 as the user destination Putar (S33 to S36 in FIG. 6). Thus, the user destination Putar and the corrected destination Pcor (actual position where the user gets off the vehicle) exist in the same block 320 (section). Therefore, the user can easily understand the positional relation between the user destination Putar and the position where the user gets off the vehicle.

In the present embodiment, if it is determined that the user destination Putar is inadequate for the vehicle to stop (S23 in FIG. 4: TRUE), the AD unit 44 (travel control device 12) causes the vehicle 10 to turn left after passing the user destination Putar, and to stop at the corrected destination Pcor over the user destination Putar in the lane 312a facing the same block 320 as the user destination Putar (FIG. 5, S33 in FIG. 6: TRUE→S34→S36).

Thus, after passing the user destination Putar, the vehicle 10 stops facing the same block 320 (section) as the user destination Putar (FIG. 5). Therefore, the user can understand more easily the positional relation between the user destination Putar and the position where the user gets off the vehicle.

In the present embodiment, if it is determined that the user destination Putar is inadequate for the vehicle to stop (S23 in FIG. 4: TRUE), the AD unit 44 (travel control device 12) notifies through the HMI 34 (notification unit) that the vehicle 10 goes to the corrected destination Pcor that is shifted from the user destination Putar (S24). Therefore, the user can find that the vehicle 10 is in the normal operation.

In the present embodiment, if it is determined that the user destination Putar is in the intersection 306, in the railroad crossing, in the construction area, or in the periphery of any of these places (S23 in FIG. 4: TRUE), the AD unit 44 (travel control device 12) causes the vehicle 10 to stop at the corrected destination Pcor that is out of the intersection 306, the railroad crossing, the construction area, or the periphery of any of these places (FIG. 6).

Thus, even if the user destination Putar is in the intersection 306, in the railroad crossing, in the construction area, or in the periphery of any of these places, the user can get off the vehicle at the adequate place.

In the present embodiment, if it is determined that other vehicle 300 stops at the user destination Putar or in the periphery thereof (S23 in FIG. 4: TRUE), the AD unit 44 (travel control device 12) causes the vehicle 10 to stop ahead of or behind the other vehicle 300 (FIG. 6). Thus, even if the other vehicle 300 stops at the user destination Putar or in the periphery thereof, the user can get off the vehicle at the adequate place.

In the present embodiment, the vehicle 10 includes the AD unit 44 (travel control device 12) and the sliding door 1101 (automatic door) (FIG. 1). If it is determined that the user destination Putar is inadequate for the vehicle to stop (S23 in FIG. 4: TRUE), the AD unit 44 causes the vehicle 10 to stop at the corrected destination Pcor that is shifted from the user destination Putar (FIG. 5 and FIG. 6) and opens the sliding door 1101 automatically (S27 in FIG. 4). Thus, the user can recognize that the current autonomous driving ends.

### B. Modifications

The present invention is not limited to the above embodiment, and various configurations can be employed on the basis of the content of the present specification. For example, the following configuration can be employed.

### B-1. Application Object

In the present embodiment, the vehicle 10 in which the travel control device 12 is used is a car (FIG. 5). However, for example, the vehicle 10 is not limited to a car from the viewpoint of, if the user destination Putar is the stop inadequate point Pia, setting the stop adequate point Pad shifted from the user destination Putar as the vehicle destination Pvtar. For example, the travel control device 12 may be used for vehicles (or movable bodies) such as trains, ships, and aircrafts.

### B-2. Vehicle 10

### [B-2-1. Automatic Door]

In the aforementioned embodiment, the vehicle 10 includes the left sliding door 1101 and the right sliding door 110r (FIG. 1). However, for example, from the viewpoint of automatically opening the door on the side opposite to the opposite lane 304b, 312b when the vehicle 10 stops, the right sliding door 110r may be omitted and only the left sliding door 1101 may be provided (in the case where vehicles keep left).

In the above embodiment, the sliding doors 1101, 110r are used as the automatic doors (FIG. 1). However, for example, the present invention is not limited to this example from the viewpoint of the door that can be opened and closed automatically. For example, a folding door (door that is used in a bus), a gullwing door, or the like can be used instead of the sliding doors 1101, 110r.

In the above embodiment, the sliding doors 1101, 110r are provided to the vehicle 10 as the automatic doors (FIG. 1). However, for example, the present invention is not limited to this example from the viewpoint of, if the user destination Putar is the stop inadequate point Pia, setting the stop adequate point Pad shifted from the user destination Putar as the vehicle destination Pvtar. For example, the vehicle 10 may exclude the automatic door.

### [B-2-2. Autonomous Driving Control]

In the above embodiment, the vehicle 10 keeps left (FIG. 5). However, for example, from the viewpoint of, if the user destination Putar is the stop inadequate point Pia, setting the stop adequate point Pad shifted from the user destination Putar as the vehicle destination Pvtar, the present invention is also applicable in the case where the vehicle 10 keeps right.

In the above embodiment, whether the vehicle destination Pvtar (=user destination Putar) is the stop adequate point Pad or the stop inadequate point Pia is determined on the basis of the external environment information Ie including the image information Iimage from the external camera 60 (or the recognition result from the external environment recognition unit 200 based on this external environment information Ie) (S22 in FIG. 4). However, for example, the present invention is not limited to this example from the viewpoint of acquiring road information for determining whether the user destination Putar is the stop adequate point Pad or the stop inadequate point Pia.

For example, in a case where an external monitoring camera exists near the user destination Putar, an image from the external monitoring camera may be received and whether the other vehicle 300 or the like exists may be determined. Thus, whether the user destination Putar is the stop adequate point Pad or the stop inadequate point Pia may be determined. Alternatively, this determination may be performed by determining the position of the other vehicle 300 on the basis of vehicle-vehicle communication with the other vehicle 300 through the communication device 32. In this case, this determination can also be performed by acquiring a scheduled stop position where the other vehicle 300 is scheduled to stop before the other vehicle 300 actually stops.

In the aforementioned embodiment, the vehicle 10 generates the target route Rtar (S12 in FIG. 3). However, for example, from the viewpoint of, if the user destination Putar is the stop inadequate point Pia, setting the stop adequate point Pad shifted from the user destination Putar as the vehicle destination Pvtar, the present invention is not limited to this example. For example, the route guide server 50 may generate the target route Rtar.

In the above embodiment, if the vehicle 10 has arrived at the vehicle destination Pvtar (S26 in FIG. 4: TRUE), the sliding door 1101 is opened (S27). However, from the viewpoint of, if the user destination Putar is the stop inadequate point Pia, setting the stop adequate point Pad shifted from the user destination Putar as the vehicle destination Pvtar, the present invention is not limited to this example. For example, the sliding door 1101 may not be automatically opened even if the vehicle 10 has arrived at the vehicle destination Pvtar (S26 in FIG. 4: TRUE).

### [B-2-3. Alternative Place Searching Process]

In the above embodiment, the vehicle 10 searches for the alternative place Pal in the range before the vehicle destination Pvtar (=user destination Putar), and then searches for the alternative place Pal in the range over the vehicle destination Pvtar (S31 to S36 in FIG. 6). However, for example, from the viewpoint of setting the corrected destination Pcor before or over the vehicle destination Pvtar (=user destination Putar), the present invention is not limited to this example. For example, if the AD unit 44 can search for the alternative place Pal in the range both before and over the vehicle destination Pvtar (=user destination Putar), the corrected destination Pcor may be set at the place over the vehicle destination Pvtar with high priority.

In the above embodiment, the alternative place searching process is performed in accordance with the procedure illustrated in FIG. 6. However, for example, the present invention is not limited to this example from the viewpoint of searching for the alternative place Pal. For example, the alternative place searching process may be varied depending on the reason why the point is the stop inadequate point Pia.

Specifically, if the user destination Putar exists in the railroad crossing or in the periphery thereof, the alternative place Pal may be obtained as below. That is to say, the AD unit 44 determines whether the user destination Putar exists over the railroad crossing. If the user destination Putar exists over the railroad crossing, the AD unit 44 sets the alternative place Pal over the railroad crossing. If the user destination Putar does not exist over the railroad crossing, the AD unit 44 sets the alternative place Pal before the railroad crossing.

In this case, if the alternative place Pal is not a parking lot, the alternative place Pal is set on the lane side facing the user destination Putar. In the case where the vehicles keep left, stopping the vehicle 10 with the user destination Putar on the left side in the traveling direction of the vehicle 10 allows the user to go out of the vehicle 10 to the user destination Putar without crossing the road. Therefore, the alternative place Pal is set on the lane side facing the user destination Putar (lane side that is closer to the user destination Putar).

In addition, if the alternative place Pal is not a parking lot, a place whose distance from the railroad crossing is the distance threshold or more and that is closest to the user destination Putar is set as the alternative place Pal. Thus, the distance for which the user needs to walk from the vehicle 10 to the user destination Putar is short.

Regarding the intersection 306 and the construction site, the alternative place Pal (or corrected destination Pcor) may be set similarly.

### [B-2-4. Stop Inadequate Point Pia]

In the above embodiment, the other vehicles 300 (for example, other vehicles 300a, 300b, 300c in FIG. 5), the intersections 306 (intersections 306a, 306b in FIG. 5), the railroad crossing, the construction site, and the periphery of these places are the stop inadequate points Pia (S23 in FIG. 4). However, for example, from the viewpoint of, if the user destination Putar is the stop inadequate point Pia, setting the stop adequate point Pad shifted from the user destination Putar as the vehicle destination Pvtar, the present invention is not limited to this example. In another example, the stop inadequate point Pia may be one, two, or three of the other vehicles 300, the intersections 306, the railroad crossing, and the construction site, or the periphery thereof. Alternatively, the stop inadequate point Pia may include a point in a streetcar travel area.

### B-3. Others

In the above embodiment, the flowcharts in FIG. 3, FIG. 4, and FIG. 6 are used. However, the procedure in each flowchart (order of steps) is not limited to the described one as long as the effects of the present invention can be obtained. For example, the order of step S38 and step S39 in FIG. 6 may be opposite.

### C. Reference Signs List

10: vehicle
12: travel control device
20: external environment sensor (peripheral environment detection unit)
34: HMI (destination input unit, notification unit)
70: GPS sensor (peripheral environment detection unit)
102: speaker (notification unit)
104: touch screen (destination input unit, notification unit)
106: microphone (destination input unit)
1101: sliding door (automatic door)
300, 300a, 300b, 300c: another vehicle
304a: travel lane for user's own vehicle (the same lane as the user destination)
306, 306a, 306b: intersection
312a: travel lane for user's own vehicle (the lane facing the same block)
320: block
Ise: peripheral environment information
Pcor: corrected destination
Putar: user destination

1. A travel control device that causes a vehicle to travel autonomously in at least a part of a route to a user destination that is input by a user through a destination input unit, the travel control device comprising one or more processors,
wherein the one or more processors:
acquire peripheral environment information from a peripheral environment detection unit;
determine whether the user destination is adequate for the vehicle to stop, on a basis of the peripheral environment information about the user destination; and
if it is determined that the user destination is inadequate for the vehicle to stop, cause the vehicle to stop at a corrected destination that is shifted from the user destination.

2. The travel control device according to claim 1, wherein if it is determined that the user destination is inadequate for the vehicle to stop, the one or more processors cause the vehicle to stop at the corrected destination that is a place over or before the user destination in a lane same as a lane of the user destination.

3. The travel control device according to claim 1, wherein if it is determined that the user destination is inadequate for the vehicle to stop, the one or more processors cause the vehicle to stop at the corrected destination that is a place over or before the user destination in a lane facing a block same as a block of the user destination.

4. The travel control device according to claim 3, wherein if it is determined that the user destination is inadequate for the vehicle to stop, the one or more processors cause the vehicle to turn left or right after passing the user destination and to stop at the corrected destination that is a place over the user destination in the lane facing the same block as the block of the user destination.

5. The travel control device according to claim 1, wherein if it is determined that the user destination is inadequate for the vehicle to stop, the one or more processors notify through a notification unit that the vehicle goes to the corrected destination that is shifted from the user destination.

6. The travel control device according to claim 1, wherein if it is determined that the user destination is in an intersection, in a railroad crossing, in a construction area, or in a periphery of any of these places, the one or more processors cause the vehicle to stop at the corrected destination that is out of the intersection, the railroad crossing, the construction area, or the periphery of any of these places.

7. The travel control device according to claim 1, wherein if it is determined that another vehicle stops at the user destination or in a periphery thereof, the one or more processors cause the vehicle to stop ahead of or behind the other vehicle.

8. A vehicle comprising:
a travel control device; and
an automatic door,
wherein the travel control device causes a vehicle to travel autonomously in at least a part of a route to a user destination that is input by a user through a destination input unit, and comprises one or more processors,
wherein the one or more processors:
acquire peripheral environment information from a peripheral environment detection unit;
determine whether the user destination is adequate for the vehicle to stop, on a basis of the peripheral environment information about the user destination; and
if it is determined that the user destination is inadequate for the vehicle to stop, cause the vehicle to stop at a corrected destination that is shifted from the user destination and open the automatic door automatically.

9. A travel control method comprising:
receiving a user destination from a user through a destination input unit;
acquiring peripheral environment information; and
making a vehicle travel autonomously in at least a part of a route to the user destination,
wherein in making the vehicle travel autonomously, whether the user destination is adequate for the vehicle to stop is determined on a basis of the peripheral environment information about the user destination, and
if it is determined that the user destination is inadequate for the vehicle to stop, the vehicle is stopped at a corrected destination that is shifted from the user destination.
